(19) United States
(12) Patent Application Publication
(10) Pub. No.: US 2022/0343217 A1
(43) Pub. Date: Oct. 27, 2022

(54) INTELLIGENT SUPPORT FRAMEWORK

(71) Applicant: Dell Products L.P., Round Rock, TX (US)

(72) Inventors: Franklin J. Mohandoss, Austin, TX (US); Bijan Kumar Mohanty, Austin, TX (US); Hung Dinh, Austin, TX (US)

(21) Appl. No.: 17/238,287

(22) Filed: Apr. 23, 2021

(51) Int. Cl. G06N 20/10; G06K 9/62; G06F 40/40

(52) U.S. Cl. CPC G06N 20/10; G06K 9/6215; G06K 9/6262; G06F 40/40

(57) ABSTRACT

A method comprises training at least one machine learning model with training data from a plurality of support cases, and receiving an input comprising data associated with at least one support case. The input is analyzed using the at least one machine learning model to determine one or more resolution options for the at least one support case, and the one or more resolution options are transmitted to an agent.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The field relates generally to information processing systems, and more particularly to providing techniques for support case analysis and problem resolution in such information processing systems.

### BACKGROUND

Many enterprises provide support to their customers for their products and/or services. Support can be sought via un-assisted/self-help support channels and assisted/agent-based support channels. Typically, the more complex customer issues are addressed via the assisted support channels. In addition, issues that are not resolved in a self-support channel may get escalated to an assisted support channel to be addressed by agents.

Although assisted support channels may provide support tools such as, for example, a knowledge base of articles and guided resolution, these tools are mostly generic and static in nature. As a result, a large amount of time is spent manually troubleshooting issues, and the efficiency and accuracy of resolutions typically depends on the skills and expertise of the individual agent assigned to the case. Due to the agents having various skill and expertise levels, customers may encounter negative support experiences where, due to lower experience levels of support agents, increased time is spent to find a resolution, resulting in higher enterprise and customer costs, and reduced customer satisfaction.

### SUMMARY

Illustrative embodiments provide techniques to use machine learning to identify and resolve support issues and/or problems.

In one embodiment, a method comprises training at least one machine learning model with training data from a plurality of support cases, and receiving an input comprising data associated with at least one support case. The input is analyzed using the at least one machine learning model to determine one or more resolution options for the at least one support case, and the one or more resolution options are transmitted to an agent.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 depicts details of an information processing system with an intelligent support framework for analyzing support cases and recommending appropriate resolutions according to an illustrative embodiment.

FIG. 2 depicts details of an operational flow for analyzing a support case and recommending appropriate resolutions according to an illustrative embodiment.

FIG. 3 depicts a diagram of a linear support vector machine (LSVM) according to an illustrative embodiment.

FIG. 4 depicts a sample of training data for training a machine learning model of a resolution recommendation engine according to an illustrative embodiment.

FIG. 5A depicts example pseudocode for splitting data into training and test sets according to an illustrative embodiment.

FIG. 5B depicts example pseudocode for training the machine learning model of the resolution recommendation engine according to an illustrative embodiment.

FIG. 6 depicts example pseudocode for generating a machine learning model performance report according to an illustrative embodiment.

FIG. 7 shows a table depicting a model performance report for test data inputted to the machine learning model of the resolution recommendation engine according to an illustrative embodiment.

FIG. 8 depicts example pseudocode for generating a confusion matrix illustrating performance of the machine learning model of the resolution recommendation engine according to an illustrative embodiment.

FIG. 9 depicts an example confusion matrix illustrating performance of the machine learning model of the resolution recommendation engine according to an illustrative embodiment.

FIG. 10 depicts details of an operational flow for recommending alternate elements according to an illustrative embodiment.

FIG. 11 depicts a graph illustrating application of a Euclidean distance algorithm in connection with different alternate parts according to an illustrative embodiment.

FIG. 12 depicts example pseudocode for computing Euclidean distance between two data vectors according to an illustrative embodiment.

FIG. 13 depicts example pseudocode for generating a set of matching parts using a nearest neighbor algorithm according to an illustrative embodiment.

FIG. 14 depicts example pseudocode for recommending alternate parts according to an illustrative embodiment.

FIG. 15 depicts a process for analyzing support cases and recommending appropriate resolutions according to an illustrative embodiment.

FIGS. 16 and 17 show examples of processing platforms that may be utilized to implement at least a portion of an information processing system according to illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Such systems are considered examples of what are more generally referred to herein as cloud-based computing environments. Some cloud infrastructures are within the exclusive control and management of a given enterprise, and therefore are considered “private clouds.” The term “enterprise” as used herein is intended to be broadly construed, and may comprise, for example, one or more businesses, one or more corporations or any other one or more entities, groups, or organizations. An “entity” as illustratively used herein may be a person or system. On the other hand, cloud infrastructures that are used by multiple enterprises, and not necessarily controlled or managed by any of the multiple enterprises but rather respectively controlled and managed by third-party cloud providers, are typically considered “public clouds.” Enterprises can choose to host their applications or services on private clouds, public clouds, and/or a combination of private and public clouds (hybrid clouds) with a vast array of computing resources attached to or otherwise a part of the infrastructure. Numerous other types of enterprise computing and storage systems are also encompassed by the term “information processing system” as that term is broadly used herein.

As used herein, “real-time” refers to output within strict time constraints. Real-time output can be understood to be instantaneous or on the order of milliseconds or microseconds. Real-time output can occur when the connections with a network are continuous and a user device receives messages without any significant time delay. Of course, it should be understood that depending on the particular temporal nature of the system in which an embodiment is implemented, other appropriate timescales that provide at least contemporaneous performance and output can be achieved.

As used herein, “natural language” is to be broadly construed to refer to any language that has evolved naturally in humans. Non-limiting examples of natural languages include, for example, English, Spanish, French and Hindi.

As used herein, “natural language processing (NLP)” is to be broadly construed to refer to interactions between computers and human (natural) languages, where computers are able to derive meaning from human or natural language input, and respond to requests and/or commands provided by a human using natural language.

As used herein, “natural language understanding (NLU)” is to be broadly construed to refer to a sub-category of natural language processing in artificial intelligence (AI) where natural language input is disassembled and parsed to determine appropriate syntactic and semantic schemes in order to comprehend and use languages. NLU may rely on computational models that draw from linguistics to understand how language works, and comprehend what is being said by a user.

In an illustrative embodiment, machine learning (ML) techniques are used to analyze historical support case data to generate support case resolution recommendations and predict needed parts (e.g., hardware, mechanical and/or other physical parts) and/or other elements (e.g., software, firmware, etc.) needed in connection with the resolution. Advantageously, an intelligent support framework leverages one or more supervised machine learning algorithms, which are trained using historical case, dispatch and elements information from customer relationship management (CRM) data to accurately predict the type of resolution needed and required parts or other elements needed in connection with the resolution. As an additional advantage, if a recommended part (or other element) is not available, the embodiments use one or more machine learning techniques to recommend alternate elements based on historical part and/or other element dispatch data. The recommended resolutions and elements are provided to agents to assist them with resolving support issues regardless of the skills and expertise of a given agent, thereby balancing the support experience across agents with varying skills and expertise. The embodiments thereby reduce the duration to complete a resolution, minimize dispatching of incorrect parts or other elements, reduce support costs and increase customer satisfaction.

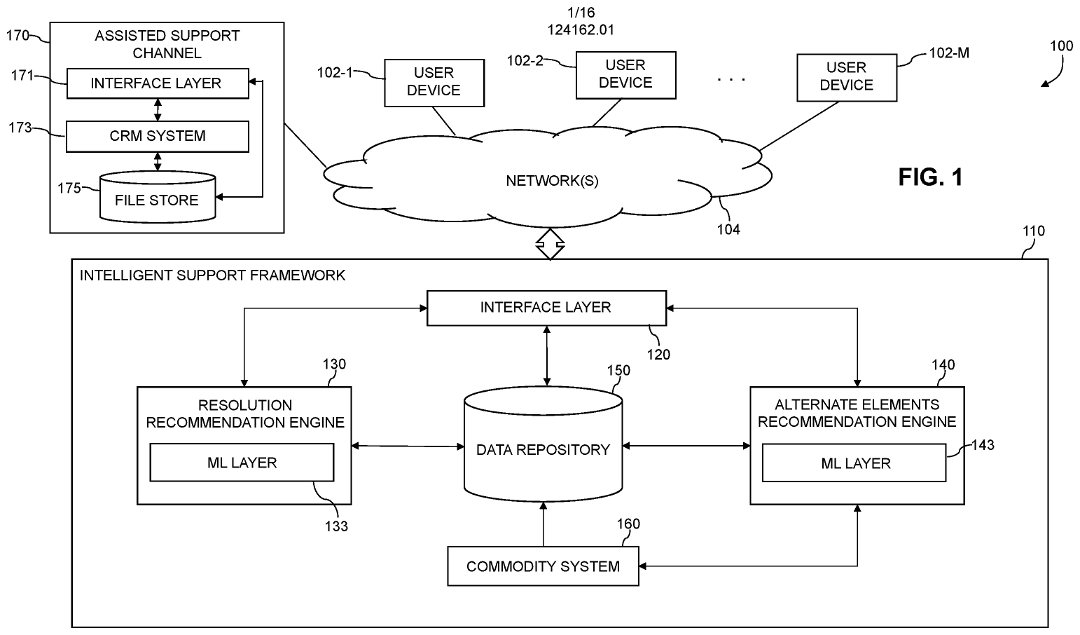

FIG. 1 shows an information processing system 100 configured in accordance with an illustrative embodiment. The information processing system 100 comprises user devices 102-1, 102-2, . . . 102-M (collectively “user devices 102”). The user devices 102 communicate over a network 104 with an intelligent support framework 110. The information processing system further comprises an assisted support channel 170, which can communicate over the network 104 with the user devices 102 and the intelligent support framework 110.

The user devices 102 can comprise, for example, Internet of Things (IoT) devices, desktop, laptop or tablet computers, mobile telephones, or other types of processing devices capable of communicating with the intelligent support framework 110 and/or the assisted support channel 170 over the network 104. Such devices are examples of what are more generally referred to herein as “processing devices.” Some of these processing devices are also generally referred to herein as “computers.” The user devices 102 may also or alternately comprise virtualized computing resources, such as virtual machines (VMs), containers, etc. The user devices 102 in some embodiments comprise respective computers associated with a particular company, organization or other enterprise. The variable M and other similar index variables herein such as K and L are assumed to be arbitrary positive integers greater than or equal to two.

The assisted support channel 170 comprises an interface layer 171, a customer relationship management (CRM) system 173 and a file store 175. According to one or more embodiments, a CRM system 173 includes technical support personnel (e.g., agents) tasked with assisting users that experience issues with their devices, systems, software, firmware, etc. Users such as, for example, customers, may contact the technical support personnel when they have device and/or system problems and require technical assistance to solve the problems. Users may access the assisted support channel 170 through one or more interfaces supported by the interface layer 171. The interfaces include multiple communication channels, for example, websites, self-service portals, email, live chat, social media, messaging services (e.g., short messaging service (SMS)), mobile applications and telephone sources. Users can access the assisted support channel 170 through their user devices 102. In response to user inquiries and/or requests for assistance, technical support personnel may create support tickets or other documentation summarizing the details and issues of corresponding support cases. The details of a support case may comprise, for example, a case title, a case description, affected device and/or device element details, and any other attributes that may be associated with a request for support. Once a support case is resolved, data corresponding to the resolution, including, for example, the steps taken to resolve the issue and any parts or other elements that required replacement and/or installation along with the original details of the support case can be stored in the file store 175 as historical records. Details of the elements that required replacement and/or installation may comprise, for example, attributes and configurations for respective ones of the elements including, but not necessarily limited to, versions, model numbers, brands and/or compatibilities.

The terms “client,” “customer” or “user” herein are intended to be broadly construed so as to encompass numerous arrangements of human, hardware, software or firmware entities, as well as combinations of such entities. Support case analysis and issue resolution services may be provided for users utilizing one or more machine learning models, although it is to be appreciated that other types of infrastructure arrangements could be used. At least a portion of the available services and functionalities provided by the intelligent support framework 110 in some embodiments may be provided under Function-as-a-Service (“FaaS”), Containers-as-a-Service (“CaaS”) and/or Platform-as-a-Service (“PaaS”) models, including cloud-based FaaS, CaaS and PaaS environments.

Although not explicitly shown in FIG. 1, one or more input-output devices such as keyboards, displays or other types of input-output devices may be used to support one or more user interfaces to the intelligent support framework 110, as well as to support communication between the intelligent support framework 110 and connected devices (e.g., user devices 102), between the assisted support channel 170 and connected devices and/or between other related systems and devices not explicitly shown.

In some embodiments, the user devices 102 are assumed to be associated with repair technicians, system administrators, information technology (IT) managers, software developers release management personnel or other authorized personnel configured to access and utilize the intelligent support framework 110.

The intelligent support framework 110 and the assisted support channel 170 in the present embodiment are assumed to be accessible to the user devices 102, and vice-versa, over the network 104. In addition, the intelligent support framework 110 is accessible to the assisted support channel 170, and vice-versa, over the network 104. The network 104 is assumed to comprise a portion of a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks. The network 104 in some embodiments therefore comprises combinations of multiple different types of networks each comprising processing devices configured to communicate using Internet Protocol (IP) or other related communication protocols.

As a more particular example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

The intelligent support framework 110, on behalf of respective infrastructure tenants each corresponding to one or more users associated with respective ones of the user devices 102, provides a platform for analyzing support cases and recommending appropriate resolutions.

Referring to FIG. 1, the intelligent support framework 110 comprises an interface layer 120, a resolution recommendation engine 130, an alternate elements recommendation engine 140, a data repository 150 and a commodity system 160. The resolution recommendation and alternate elements recommendation engines 130 and 140 comprise machine learning (ML) layers 133 and 143.

The intelligent support framework 110 uses historical case resolution information including, for example, the case and resolution details described above, to recommend resolution options and/or needed parts or other elements for received support cases. The intelligent support framework 110 transmits the resolution options and needed elements to agents of an assisted support channel 170 in real-time so that the agents may use and/or rely on the resolution options and needed elements during their troubleshooting and resolution workflow when assisting users with their support cases. The resolution recommendation engine 130 uses one or more machine learning models to analyze the historical case information and recommend resolutions including soft solutions (e.g., driver, firmware and/or software installations and/or upgrades) and/or hard solutions (e.g., parts replacement). The alternate elements recommendation engine 140 of the intelligent support framework 110 recommends alternate elements (e.g., parts, devices, software, firmware, drivers) if the elements set forth in the resolution options from the resolution recommendation engine 130 are not available in inventory.

The historical case resolution information can be stored in the file store 175 and sent to the intelligent support framework 110 to be stored in the data repository 150. As explained further herein, different portions of the historical case resolution information are used to train machine learning models of the ML layers 133 and 143 of the resolution recommendation and alternate elements recommendation engines 130 and 140.

As noted herein above, support requests from users are sent to the assisted support channel 170 from user devices 102 via various channels including, but not necessarily limited to, voice (e.g., via mobile or land line telephone), SMS, email, chat, websites, social media and/or self-service portals. Once the requests are documented into for example, support tickets and/or incident reports and assigned to the agents, the support case details are sent from the assisted support channel 170 to the intelligent support framework 110 and received via the interface layer 120. Similar to the interface layer 171, the interface layer 120 supports multiple communication channels, for example, websites, self-service portals, email, live chat, social media, messaging services, mobile applications and telephone sources.

The support case details are sent from the interface layer 120 to the resolution recommendation engine 130, which uses one or more machine learning models to analyze the incoming support case details and recommend one or more resolutions that may be needed to resolve the issue. The recommended resolutions are based on similar issues in the historical data. For example, in case of software and/or configuration issues, the resolution recommendation engine 130 can recommend the type of firmware or software (e.g., basic input/output system (BIOS), operating system (OS), device driver, patches, etc.) that needs to be installed and/or upgraded. In case of hardware-based issues (e.g., defective and/or failed devices and/or parts), the resolution recommendation engine 130 will recommend the type of actions needed for resolving an issue including the elements required to fix and/or solve the issue. Once the recommendation is transmitted to an agent, if the agent finds that needed elements recommended by the resolution recommendation engine 130 are not available in inventory, a notification that a required element is not available is transmitted from the assisted support channel 170 to the intelligent support framework 110. Responsive to the notification, the interface layer 120 may trigger an application programming interface (API) call to the alternate elements recommendation engine 140. Using one or more machine learning models, the ML layer 143 of the alternate elements recommendation engine 140 will analyze inputted details of the needed element(s) to return a list of similar alternate parts that will be appropriate to use in place of the recommended element that is not available. The alternate elements recommendation engine 140 accesses the commodity system 160, which comprises details about available parts or other elements that may be used instead of a recommended part or element that is unavailable or otherwise not able to be used in connection with a given resolution.

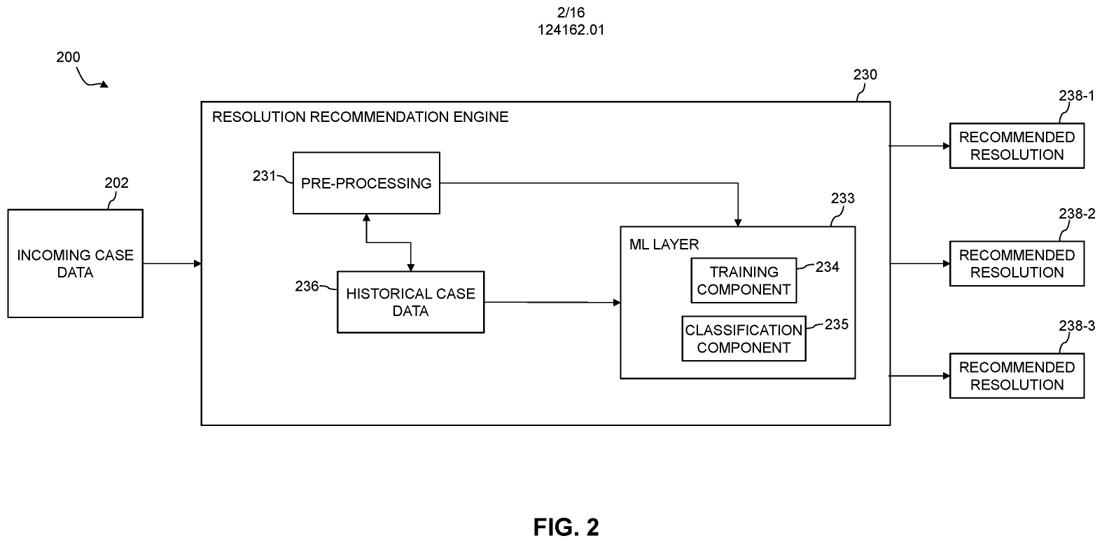

In more detail, referring to the operational flow 200 in FIG. 2, incoming support case data 202 is sent to the resolution recommendation engine 230 (which is the same or similar to the resolution recommendation engine 130). Considering case titles, descriptions and other data associated with support cases include natural language, a pre-processing component 231 processes the incoming case data 202 and the historical case data 236 to be analyzed using NLP. For example, the pre-processing component 231 cleans any unwanted characters and stop words. The pre-processing further comprises stemming and lemmatization, as well as changing text to lower case, removing punctuation, and removing incorrect or unnecessary characters. According to one or more embodiments, Porter stemming and lemmatization is used. Additionally or alternatively, a natural language toolkit (NLTK) library and/or other libraries can also be used. Once pre-processing and data cleanup is performed, an input list of words (e.g., in a sentence or phrase) is tokenized. Tokenization can be performed using, for example, a Keras library or NLTK library. A Keras tokenizer class can be used to index the tokens. In one or more embodiments, a term frequency-inverse document frequency (TF-IDF) vectorizer and trigrams are used. After tokenization is performed, the resulting words are padded to make the words have equal lengths so that the words can be used in the machine learning model.

TF-IDF is a numerical statistic in NLP that reflects how important a word is to a document in a collection. In general, the TF-IDF algorithm is used to weigh a keyword in any document and assign an importance to that keyword based on the number of times the keyword appears in the document. Each word or term has its respective TF and IDF score. The product of the TF and IDF scores of a term is referred to as the TF-IDF weight of that term. The higher the TF-IDF weight (also referred to herein as “TF-IDF score”), the rarer and more important the term, and vice versa. It is to be understood that the embodiments are not limited to the use of TF-IDF, and there are alternative methodologies for text vectorization.

In illustrative embodiments, the TF-IDF vectorizer is generated and used to build a TF-IDF matrix, which includes each word and its TF-IDF score for each case data entry in the incoming case data 202 and the historical case data 236 (e.g., each entry in the data repository 150). According to an embodiment, a TfidfVectorizer function from a SciKitLearn library is used to build the vectorizer.

As can be seen in FIG. 2, the resolution recommendation engine 230 analyzes the incoming case data 202 using an ML layer 233 comprising training and classification components 234 and 235. The ML layer is the same or similar to ML layer 133. Based on the analysis, the classification component 235 generates one or more recommended resolutions (e.g., recommended resolutions 238-1, 238-2 and/or 238-3) to address issues associated with an incoming support case. Although three recommended resolutions 238-1 to 238-3 are shown in FIG. 2, the embodiments are not necessarily limited thereto, and more or less recommended resolutions can be generated based on incoming case data 202. The ML layer 233 leverages a supervised machine learning algorithm, which is trained via the training component 234 with historical support information comprising, for example, case titles, case descriptions, affected device or element details and elements requiring replacement and/or installation.

According to the embodiments, the machine learning model is trained using historical case and work order information that contains feature sets the model can use for resolution prediction. In an illustrative example, for a support use case, training data includes the title and description of the case which includes, for example, the issues and symptoms encountered by a user (e.g., customer). The training data also includes device details such as, for example, the model, operating system (OS) and other software details. If a hardware-related resolution was performed, the part numbers of the commodities dispatched to fix the issue are also part of the training data. In the case of software-based resolution, the training data may include information such as, for example, the type of software or configuration used to fix the issue, such as OS patches, BIOS, drivers and security patches.

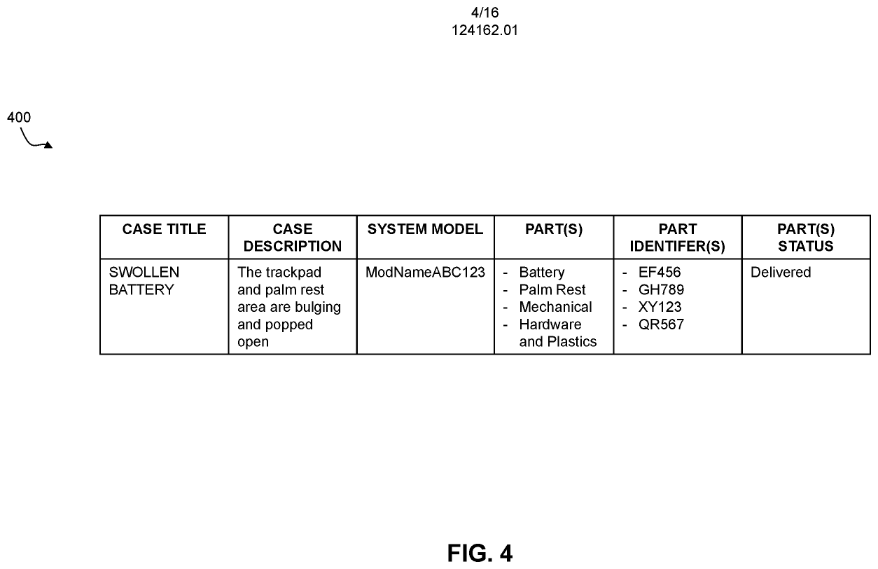

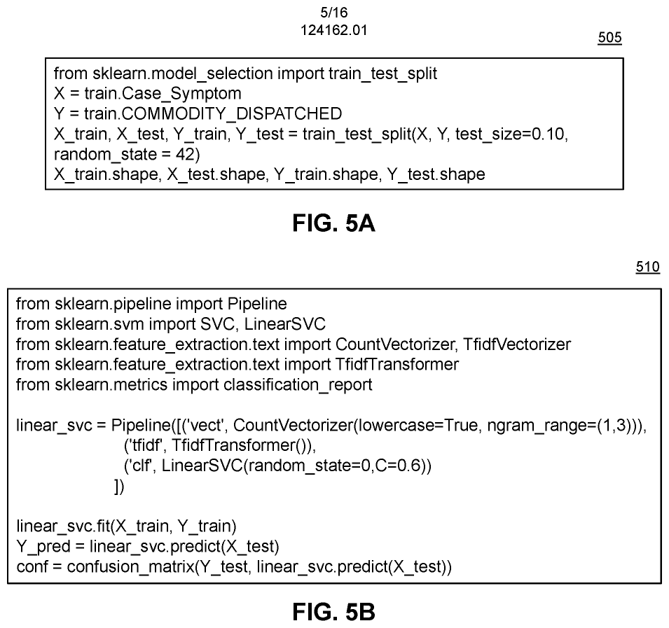

For example, referring to the chart 400 in FIG. 4, a portion of sample training data relates to a swollen battery (case title) of a laptop computer (model ModNameABC123), where “a trackpad and palm rest are bulging and popped open” (case description). The parts associated with this case include, for example, a battery, palm rest and corresponding mechanical parts, hardware and plastics. The parts are identified by identifiers (e.g., part numbers) and a status of whether the parts were delivered is indicated. Such data may be provided for multiple cases (e.g., thousands of cases). FIG. 5A depicts example pseudocode 505 for splitting data into training and test sets and FIG. 5B depicts example pseudocode 510 for training the machine learning model of the resolution recommendation engine 230 (or 130).

The classification component 235 generates recommended resolutions 238 comprising options to address the issue(s) associated with the incoming case data 202. The recommendations are not limited to one specific type of issue, and can address, for example, software issues, configuration issues, hardware issues, issues with parts or other elements, or combinations thereof. Some examples of recommended resolutions comprise, but are not necessarily limited to, installing a BIOS, replacing a hard drive, replacing hardware and installing a driver.

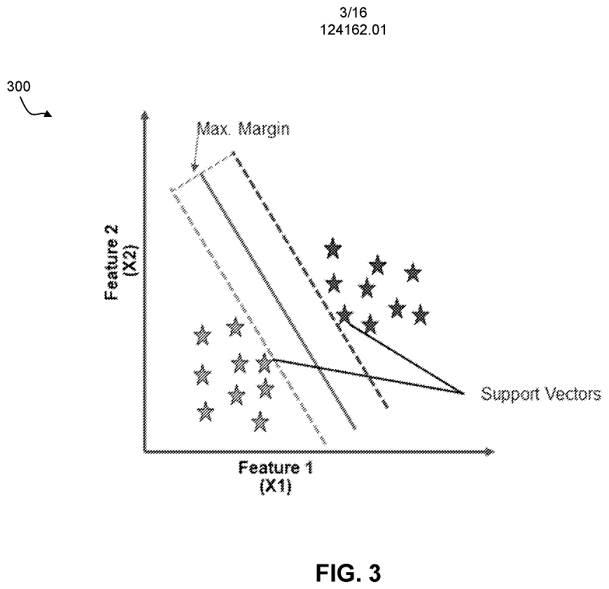

In one or more embodiments, the supervised learning algorithm used by the ML layer 233 comprises a support vector machine (SVM), which is a supervised machine learning algorithm capable of performing classification, regression and outlier detection. The classification component comprises a linear SVM (LSVM) classifier. Referring to the diagram 300 in FIG. 3, the LSVM classifier draws a straight line between two classes. The data points that fall on one side of the line (e.g., left side) will be labeled as one class and the data points that fall on the other side (e.g., right side) will be labeled as a second class. Although there are an infinite number of lines that may be drawn, the LSVM classifier of the embodiments utilizes a line that separates the two classes and is farthest away from the closest samples (“Maximum (Max.) Margin”). The “support vector” in “support vector machine” refers to two position vectors drawn from the origin (0, 0) to the points which dictate the decision boundary.

The case data for a support case assigned to an agent of the assisted support channel 170 is sent to the trained machine learning model of the resolution recommendation engine 130/230 to generate one or more resolution recommendations with varying degrees of confidence (e.g., likelihood that the resolution is the correct resolution for a given case). According to an embodiment, the resolution options are displayed for an agent in a descending order with recommended resolutions having higher confidence being ranked higher than recommended resolutions having lower confidences. According to one or more embodiments, implementation of a support process using a particular resolution option can be fully automated when a given confidence score for the particular resolution option exceeds a threshold.

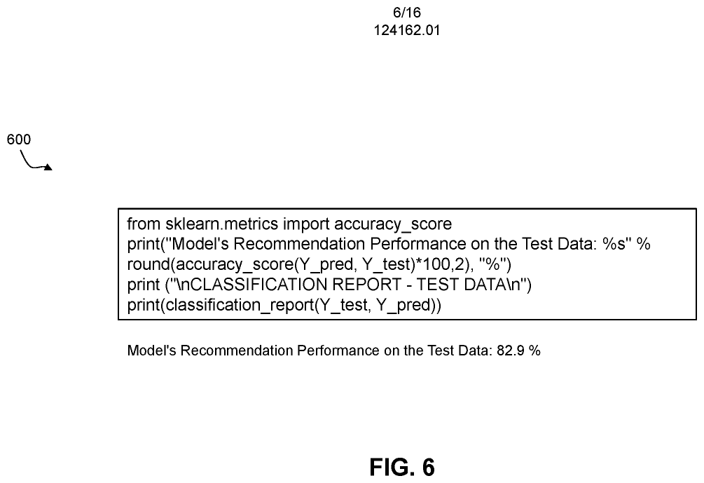

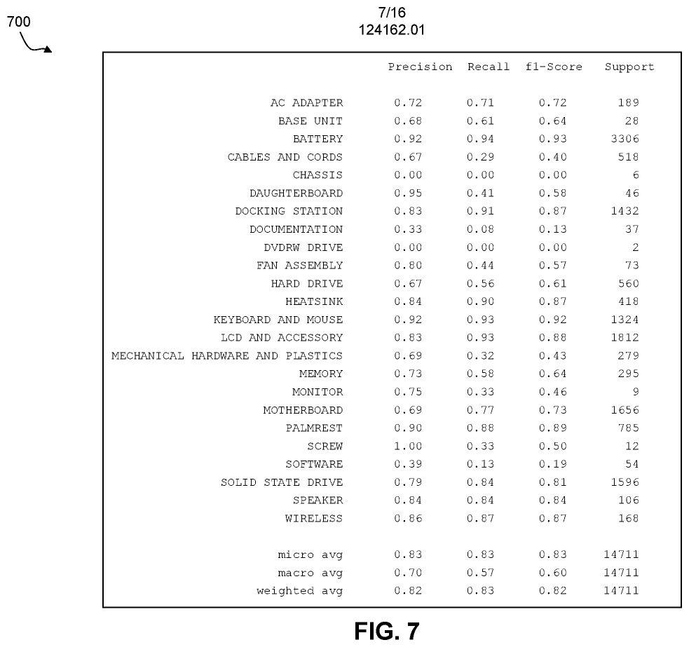

In one or more embodiments, to ensure that the machine learning model using the LSVM classifier is not an over-fitted, the model is evaluated for performance using K-folds cross validation. In general, an over-fitted model performs well on the training data, but performs poorly on the test data or in a real scenario. To evaluate the performance, the embodiments utilize a K-folds cross validation with a K value of 50. In the case of a 50-folds cross validation, a data sample is separated into 50 groups of randomly sampled data. One group is used for testing and prediction, and the remaining 49 groups of data are used for training. This process is repeated with a different group being selected for testing each time the process is repeated, while the remaining groups are used for training. The evaluation process is an attempt to ensure that the selected model is optimized to provide the best accuracy and F1 score. FIG. 6 depicts example pseudocode 600 for generating a performance report of the machine learning model, and FIG. 7 shows a table 700 depicting a model performance report with 50-folds cross validation for test data inputted to the machine learning model of the resolution recommendation engine 130/230. In FIG. 7, “precision” corresponds to the ratio of correct positive predictions to the total positive predictions. High precision relates to a low false positive rate. “Recall” corresponds to the ratio of correct positive predictions to all observations in a class. “F1-score” is the weighted average of precision and recall, and “support” refers to the number of cases.

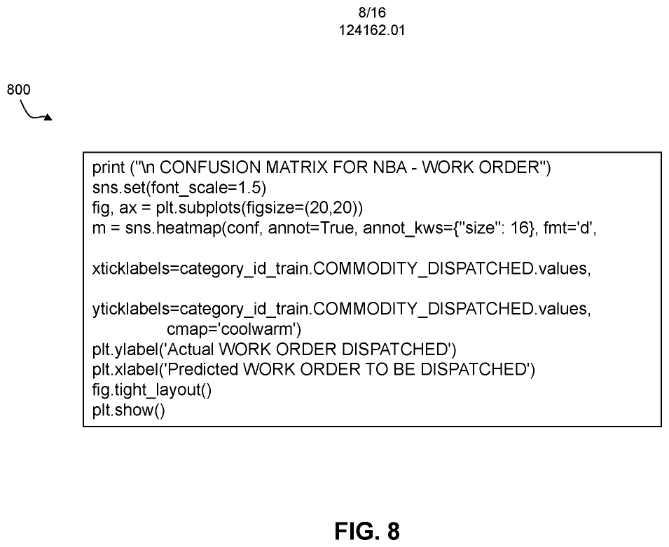

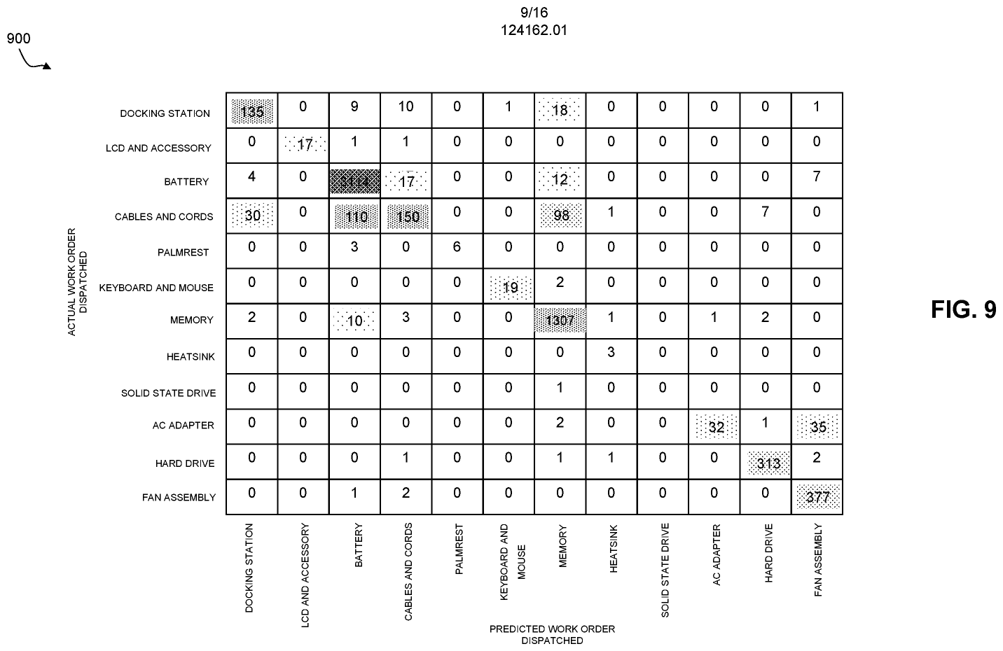

FIG. 8 depicts example pseudocode 800 for generating a confusion matrix illustrating performance of the machine learning model of the resolution recommendation engine 130/230, and FIG. 9 depicts an example confusion matrix 900 (e.g., heatmap) illustrating performance of the machine learning model of the resolution recommendation engine 130/230. The confusion matrix 900 indicates how well the model recommended resolutions by comparing the recommended resolutions against actual dispatched resolutions for a plurality of received support cases.

In more detail, the vertical axis (y-axis) of the confusion matrix 900 corresponds to actual dispatched work orders and the horizontal axis (x-axis) corresponds predicted dispatched work orders. The categories listed for the actual work orders are the same as the categories listed for predicted work orders. The predicted work orders correspond to the recommended resolutions identified by the resolution recommendation engine 130/230, whereas the actual work orders correspond to those categories that are the work orders that were actually dispatched to respond to and solve the issues of the support cases. The numbers at the intersections of the predicted and true labels represent the number of times that a predicted work order (e.g., resolution) matches with the actual work order (e.g., resolution). For example, “battery” as a predicted resolution was correct 3114 times, “memory” as a predicted resolution was correct 1307 times, “hard drive” as a predicted resolution was correct 313 times, and “fan assembly” as a predicted resolution was correct 377 times. In some other cases, the categories were correct less than 10 times, from 10 to 150 times and greater than 150 times.

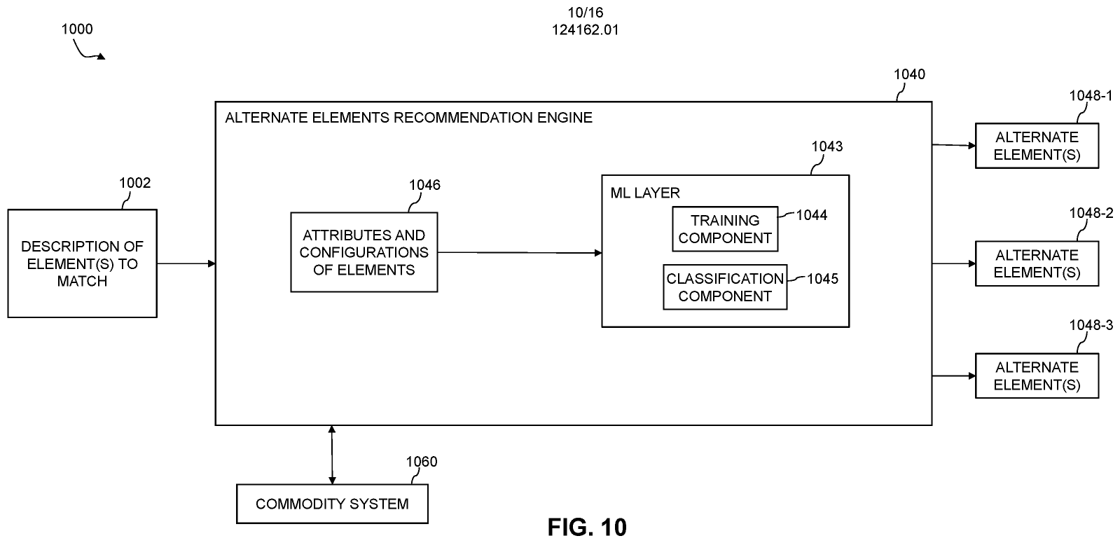

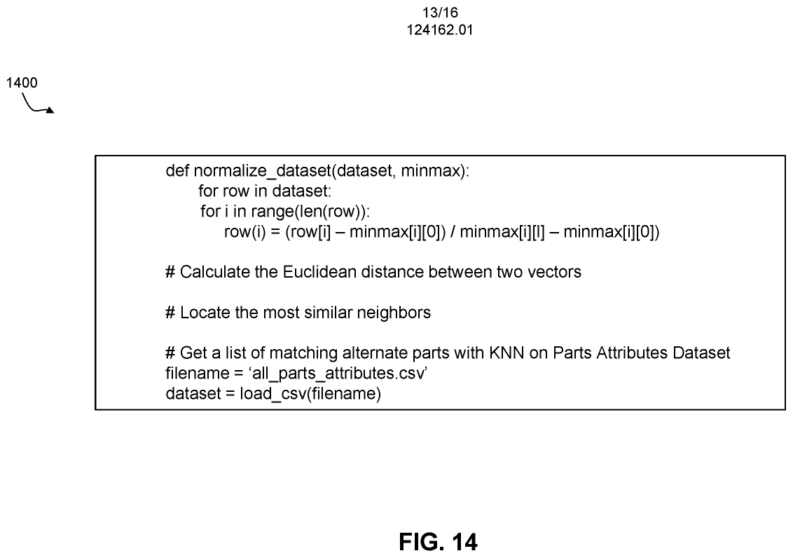

Referring to the operational flow 1000 for recommending alternate elements in FIG. 10, the alternate elements recommendation engine 1040 (which is the same as or similar to the alternate elements recommendation engine 140 in FIG. 1) identifies alternate elements when an originally recommended part or other element in a resolution option from the resolution recommendation engine 130/230 is not available. A description of the element(s) needed to be matched by the alternate element(s) is provided as input 1002 to the alternate elements recommendation engine 1040. The inputted description 1002 comprises, for example, attributes and configurations of the unavailable elements including, but not necessarily limited to, versions, model numbers, brands and/or compatibilities. As noted herein, the elements can comprise, for example, soft solutions (e.g., drivers, firmware and/or software installations and/or upgrades) and/or hard solutions (e.g., parts, device replacement). The alternate elements recommendation engine 1040 recommends alternate elements (e.g., parts, devices, software, firmware, drivers) if the elements set forth in the resolution options from the resolution recommendation engine 130 are not available. As shown in FIG. 10, one or more alternate elements 1048-1, 1048-2 and 1048-3 can be recommended. It is to be understood that the embodiments are not limited to three alternate elements, and more or less than three alternate elements can be recommended by the alternate elements recommendation engine 1040. FIG. 14 depicts example pseudocode 1400 for recommending alternate parts in connection with the operation of the alternate elements recommendation engine 1040.

The alternate elements recommendation engine 1040 comprises an ML layer 1043 (which is the same as or similar to the ML layer 143) comprising a classification component 1045, which uses one or more machine learning algorithms to analyze the inputted description 1002 and with reference to a commodity system 1060, identifies all alternate elements with similar attributes and configurations to the originally recommended element(s). The commodity system 1060 comprises details about available parts or other elements that may be used instead of a recommended part or element that is unavailable or otherwise not able to be used in connection with a given resolution.

The classification component 1045 uses a combination of a K-nearest neighbor (KNN) supervised learning algorithm and a Euclidean distance algorithm to measure similarity. The KNN algorithm used by the embodiments comprises a non-parametric, lazy learning algorithm, that does not make assumptions on the underlying data. The KNN algorithm of the embodiments concludes that data points with similar classes are closer to each other than data points from non-similar and/or different classes. The KNN algorithm selects similar data points based on their proximities to each other regardless of what features numerical values may represent.

According to the embodiments, the training component 1044 of the ML layer 1043 uses attributes and configurations for respective ones of a plurality of elements (element 1046) to train the machine learning models used by the classification component 1045. Such training data can be stored in a data repository (e.g., data repository 150).

When a description of an originally recommended part or other element (1002) is received by the alternate elements recommendation engine 1040, K-most similar records to the originally recommended element of elements from the training data set are identified. From these neighboring datasets of elements, the classification component 1045 generates a summarized prediction of alternate elements. The embodiments can use a plurality of distance algorithms to the measure the similarities of the K-most similar records to the originally recommended element including, for example, Manhattan distance, Minkowski distance and/or Euclidean distance.

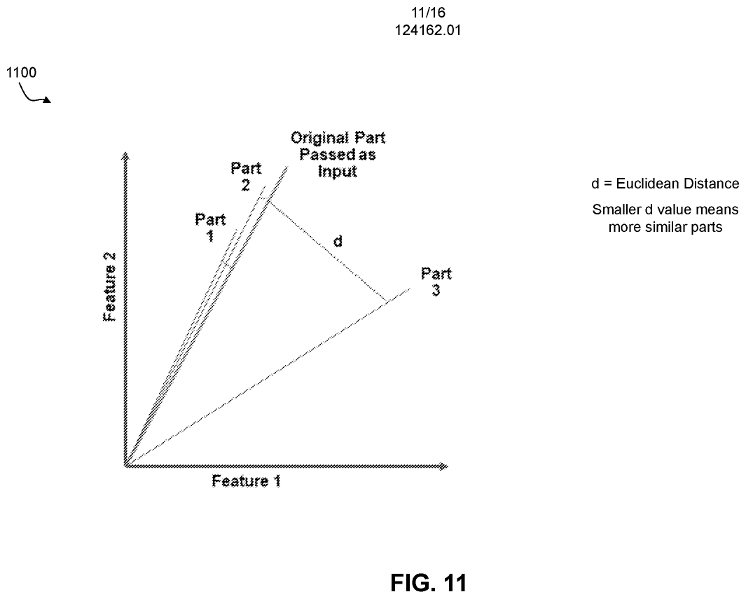

According to an embodiment, element attributes that are categorical are encoded and Euclidean distance between different elements is calculated. Referring, for example, to the diagram 1100 in FIG. 11, Euclidean distance comprises a straight-line distance between two vectors or data points. The Euclidean distance is calculated by computing the square root of the sum of the squared differences between the two data points (e.g., vectors). The equation (1) for the Euclidean distance algorithm used by the embodiments is set forth as follows:

Euclidean Distance=\sqrt{Σₙⁱ(x1ᵢ−x2ᵢ)²} (1)

In equation (1), x1 refers to a first row of data, x2 refers to a second row of data and i is the index to a specific column. The diagram 1100 in FIG. 11 depicts Euclidean distance between different alternate parts (Part 1, Part 2 and Part 3) and an original inputted part based on features 1 and 2. There may be more or less than two features.

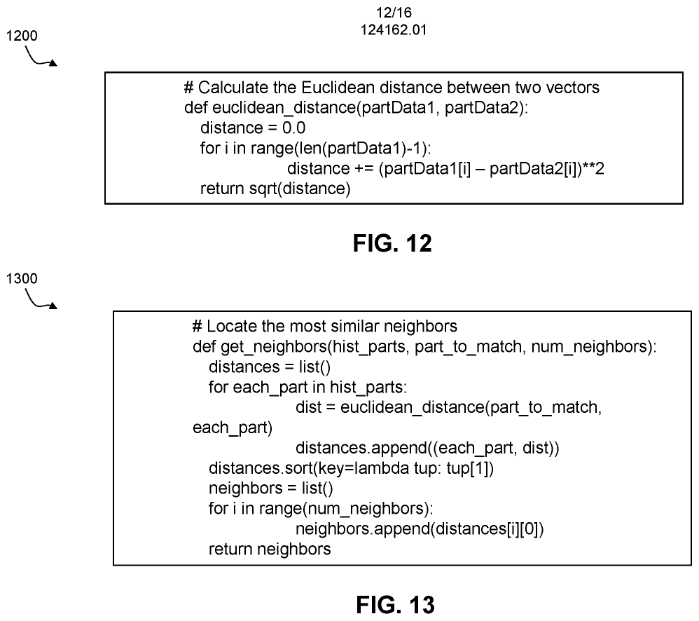

FIG. 12 depicts example pseudocode 1200 for computing Euclidean distance between two data vectors. With Euclidean distance, smaller values mean more similar records. A zero distance means that the compared elements are exactly the same, with all matching attributes and configurations.

Once the distance is calculated between an originally recommended element and the possible alternate elements from a dataset of alternate elements provided at least in part by the commodity system 1060 and/or the training data 1046, K-nearest neighbor matching is performed. Since the KNN algorithm used by the embodiments comprises a lazy algorithm, the algorithm uses the training dataset 1046 for prediction.

Neighbors for the originally recommended elements are the K closest instances. In order to identify the neighbors for the originally recommended elements, the ML layer 1043 computes the distance between each record in the training dataset 1046 to the originally recommended elements using, for example, Euclidean distance. Once distances are calculated, the records in the training dataset 1046 are ordered according to their distances from the originally recommended elements. The top K elements from the ordered list are returned as the most similar neighbors to an originally recommended element. In one or more embodiments, the classification component 1045 tracks the distance for each record in the dataset 1046 as a tuple, sorts the list of tuples by the distance (e.g., in descending order) and retrieves the nearest neighbors. FIG. 13 depicts example pseudocode 1300 for generating a K set of matching parts using the nearest neighbor algorithm. In the code 1300, “hist_parts” refers to parts in the dataset 1046, “part_to_match” refers to an originally recommended part that is not available, and “num_neighbors” refers to the number (K) of similar neighbors. According to one or more embodiments, K is the number of neighbors (num_neighbors) that can be tuned as part of hyper parameter tuning to improve the performance of the model to return most similar neighbors.

According to one or more embodiments, databases or datasets (e.g., datasets 236 and 1046), repositories (e.g., repository 150), stores (e.g., file store 175) and/or corpuses used by the intelligent support framework 110 and/or assisted support channel 170 can be configured according to a relational database management system (RDBMS) (e.g., PostgreSQL). Databases, datasets, repositories, stores and/or corpuses in some embodiments are implemented using one or more storage systems or devices associated with the intelligent support framework 110 and/or assisted support channel 170. In some embodiments, one or more of the storage systems utilized to implement the databases comprise a scale-out all-flash content addressable storage array or other type of storage array.

The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although shown as elements of the intelligent support framework 110, the interface layer 120, the resolution recommendation engine 130, the alternate elements recommendation engine 140, the data repository 150 and the commodity system 160 in other embodiments can be implemented at least in part externally to the intelligent support framework 110, for example, as stand-alone servers, sets of servers or other types of systems coupled to the network 104. For example, the interface layer 120, the resolution recommendation engine 130, the alternate elements recommendation engine 140, the data repository 150 and/or the commodity system 160 may be provided as cloud services accessible by the intelligent support framework 110.

The interface layer 120, the resolution recommendation engine 130, the alternate elements recommendation engine 140, the data repository 150 and the commodity system 160 in the FIG. 1 embodiment are each assumed to be implemented using at least one processing device. Each such processing device generally comprises at least one processor and an associated memory, and implements one or more functional modules for controlling certain features of the interface layer 120, the resolution recommendation engine 130, the alternate elements recommendation engine 140, the data repository 150 and/or the commodity system 160.

At least portions of the intelligent support framework 110 and the components thereof may be implemented at least in part in the form of software that is stored in memory and executed by a processor. The intelligent support framework 110 and the components thereof comprise further hardware and software required for running the intelligent support framework 110, including, but not necessarily limited to, on-premises or cloud-based centralized hardware, graphics processing unit (GPU) hardware, virtualization infrastructure software and hardware, Docker containers, networking software and hardware, and cloud infrastructure software and hardware.

Although the interface layer 120, the resolution recommendation engine 130, the alternate elements recommendation engine 140, the data repository 150, the commodity system 160 and other components of the intelligent support framework 110 in the present embodiment are shown as part of the intelligent support framework 110, at least a portion of the interface layer 120, the resolution recommendation engine 130, the alternate elements recommendation engine 140, the data repository 150, the commodity system 160 and other components of the intelligent support framework 110 in other embodiments may be implemented on one or more other processing platforms that are accessible to the intelligent support framework 110 over one or more networks. Such components can each be implemented at least in part within another system element or at least in part utilizing one or more stand-alone components coupled to the network 104.

It is assumed that the intelligent support framework 110 in the FIG. 1 embodiment and other processing platforms referred to herein are each implemented using a plurality of processing devices each having a processor coupled to a memory. Such processing devices can illustratively include particular arrangements of compute, storage and network resources. For example, processing devices in some embodiments are implemented at least in part utilizing virtual resources such as virtual machines (VMs) or Linux containers (LXCs), or combinations of both as in an arrangement in which Docker containers or other types of LXCs are configured to run on VMs.

The term “processing platform” as used herein is intended to be broadly construed so as to encompass, by way of illustration and without limitation, multiple sets of processing devices and one or more associated storage systems that are configured to communicate over one or more networks.

As a more particular example, the interface layer 120, the resolution recommendation engine 130, the alternate elements recommendation engine 140, the data repository 150, the commodity system 160 and other components of the intelligent support framework 110, and the elements thereof can each be implemented in the form of one or more LXCs running on one or more VMs. Other arrangements of one or more processing devices of a processing platform can be used to implement the interface layer 120, the resolution recommendation engine 130, the alternate elements recommendation engine 140, the data repository 150 and the commodity system 160, as well as other components of the intelligent support framework 110. Other portions of the system 100 can similarly be implemented using one or more processing devices of at least one processing platform.

Distributed implementations of the system 100 are possible, in which certain components of the system reside in one datacenter in a first geographic location while other components of the system reside in one or more other data centers in one or more other geographic locations that are potentially remote from the first geographic location. Thus, it is possible in some implementations of the system 100 for different portions of the intelligent support framework 110 to reside in different data centers. Numerous other distributed implementations of the intelligent support framework 110 are possible.

Accordingly, one or each of the interface layer 120, the resolution recommendation engine 130, the alternate elements recommendation engine 140, the data repository 150, the commodity system 160 and other components of the intelligent support framework 110 can each be implemented in a distributed manner so as to comprise a plurality of distributed components implemented on respective ones of a plurality of compute nodes of the intelligent support framework 110.

It is to be appreciated that these and other features of illustrative embodiments are presented by way of example only, and should not be construed as limiting in any way.

Accordingly, different numbers, types and arrangements of system components such as the interface layer 120, the resolution recommendation engine 130, the alternate elements recommendation engine 140, the data repository 150, the commodity system 160 and other components of the intelligent support framework 110, and the elements thereof can be used in other embodiments.

It should be understood that the particular sets of modules and other components implemented in the system 100 as illustrated in FIG. 1 are presented by way of example only. In other embodiments, only subsets of these components, or additional or alternative sets of components, may be used, and such components may exhibit alternative functionality and configurations.

For example, as indicated previously, in some illustrative embodiments, functionality for the intelligent support framework can be offered to cloud infrastructure customers or other users as part of FaaS, CaaS and/or PaaS offerings.

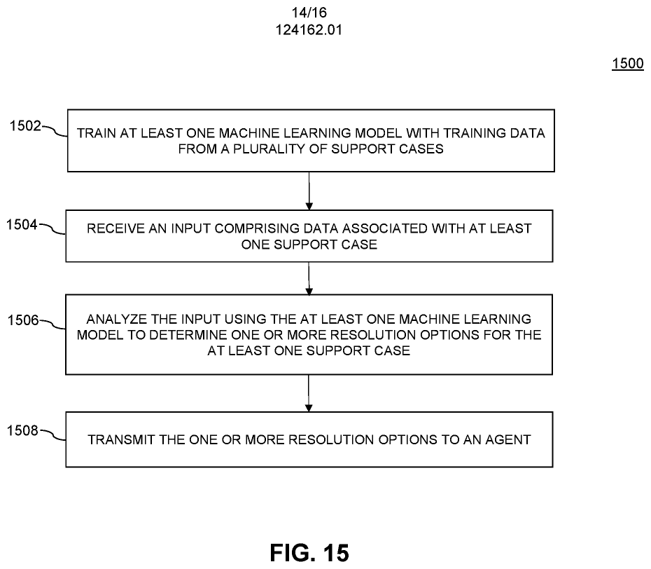

The operation of the information processing system 100 will now be described in further detail with reference to the flow diagram of FIG. 15. With reference to FIG. 15, a process 1500 for analyzing support cases and recommending appropriate resolutions as shown includes steps 1502 through 1508, and is suitable for use in the system 100 but is more generally applicable to other types of information processing systems comprising an intelligent support framework configured for analyzing support cases and recommending appropriate resolutions.

In step 1502, at least one machine learning model is trained with training data from a plurality of support cases. The at least one machine learning model comprises an LSVM classifier. For respective ones of the plurality of support cases, the training data comprises at least one of a case title, a case description, affected device details and one or more elements requiring at least one of replacement and installation.

In step 1504, an input comprising data associated with at least one support case is received. In step 1506, the input is analyzed using the at least one machine learning model to determine one or more resolution options for the at least one support case.

In step 1508, the one or more resolution options are transmitted to an agent. A degree of confidence is computed for respective ones of the one or more resolution options, and the computed degrees of confidence are transmitted with the one or more resolution options to the agent. The process further comprises performing NLP on the training data from the plurality of support cases and the data associated with the at least one support case.

According to an illustrative embodiment, the one or more resolution options comprise one or more recommendations for at least one of a replacement and an installation of an element. The element may comprise a device part, and one or more alternative parts to be used instead of the device part are recommended. The recommending is performed using at least one other machine learning model. The at least one other machine learning model is trained with data comprising attributes and configurations for respective ones of a plurality of parts. The recommending comprises comparing the device part to a plurality of alternative parts to determine a level of similarity between the device part and respective ones of the plurality of alternative parts. According to one or more embodiments, the comparing is performed using a KNN algorithm and/or a Euclidean distance algorithm.

The process further includes evaluating performance of the at least one machine learning model, wherein the evaluating is performed using K-folds cross validation. A visualization of the performance of the at least one machine learning model is generated. The visualization comprises a confusion matrix comprising dispatched resolutions versus recommended resolutions for a plurality of received support cases.

It is to be appreciated that the FIG. 15 process and other features and functionality described above can be adapted for use with other types of information systems configured to execute support case analysis and problem resolution services in an intelligent support framework or other type of platform.

The particular processing operations and other system functionality described in conjunction with the flow diagram of FIG. 15 is therefore presented by way of illustrative example only, and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Functionality such as that described in conjunction with the flow diagram of FIG. 15 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Illustrative embodiments of systems with an intelligent support framework as disclosed herein can provide a number of significant advantages relative to conventional arrangements. For example, unlike conventional techniques, the embodiments advantageously provide techniques to use machine learning to programmatically formulate with high accuracy correlations between issues requiring support and the resolutions to address the issues. Such issues may correspond to software and/or hardware installation and/or replacement. The machine learning models advantageously learn and build insights for issue prediction and resolution recommendation. Using NLP and LSVM classification, the machine learning model proactively recommends implementable resolution steps to an agent which may include configuration changes and/or element replacements and/or installations.

As an additional advantage, the embodiments provide a framework that uses a combination of similarity and distance-based algorithms (e.g., KNN and Euclidean distance) to identify alternate parts or other elements when the original parts or other elements are not available for dispatch.

Conventional approaches typically leverage large pools of agents with varying skills, which results in unequal support experiences for users. In addition, when using conventional approaches, support cases may be wrongly diagnosed, and wrong parts may be dispatched. Advantageously, the embodiments provide an optimized machine learning framework that combines select machine learning techniques to analyze incoming support cases and recommend appropriate resolutions to agents of assisted support channels. As a result, user experience can be universally improved regardless of the skills of the agent. As an additional advantage, the intelligent support framework analyzes options for alternate parts or other elements and matches available alternatives with originally recommended elements needed for a resolution when such elements are unavailable.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As noted above, at least portions of the information processing system 100 may be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform that may be used to implement at least a portion of an information processing system comprise cloud infrastructure including virtual machines and/or container sets implemented using a virtualization infrastructure that runs on a physical infrastructure. The cloud infrastructure further comprises sets of applications running on respective ones of the virtual machines and/or container sets.

These and other types of cloud infrastructure can be used to provide what is also referred to herein as a multi-tenant environment. One or more system components such as the intelligent support framework 110 or portions thereof are illustratively implemented for use by tenants of such a multi-tenant environment.

As mentioned previously, cloud infrastructure as disclosed herein can include cloud-based systems. Virtual machines provided in such systems can be used to implement at least portions of one or more of a computer system and an intelligent support framework in illustrative embodiments. These and other cloud-based systems in illustrative embodiments can include object stores.

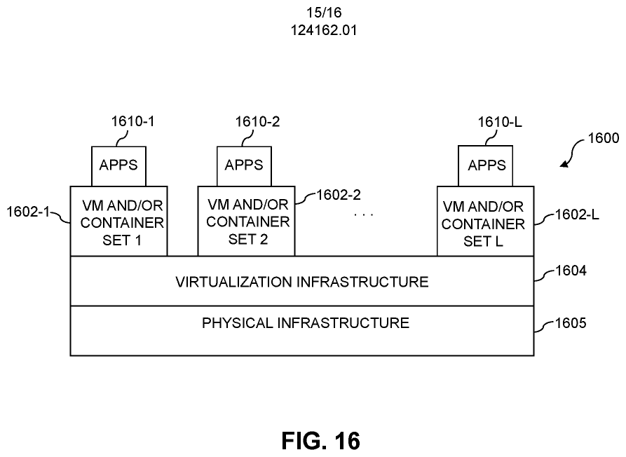

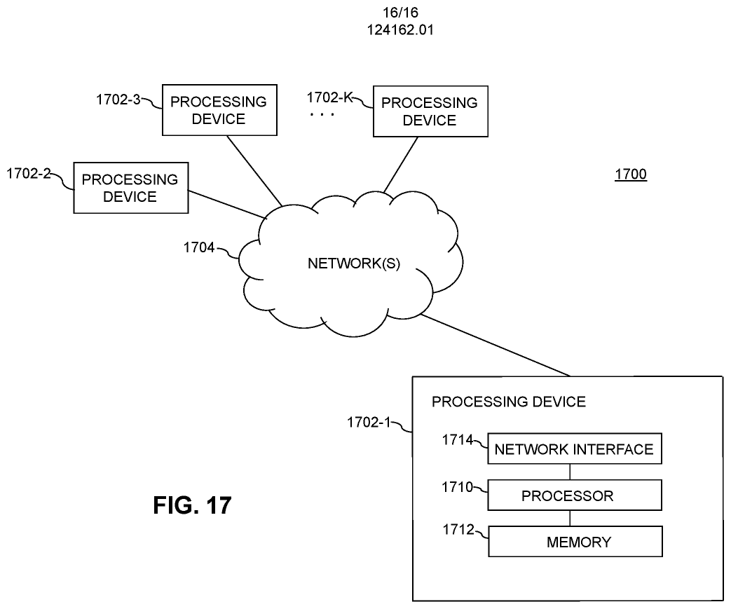

Illustrative embodiments of processing platforms will now be described in greater detail with reference to FIGS. 16 and 17. Although described in the context of system 100, these platforms may also be used to implement at least portions of other information processing systems in other embodiments.

FIG. 16 shows an example processing platform comprising cloud infrastructure 1600. The cloud infrastructure 1600 comprises a combination of physical and virtual processing resources that may be utilized to implement at least a portion of the information processing system 100. The cloud infrastructure 1600 comprises multiple virtual machines (VMs) and/or container sets 1602-1, 1602-2, . . . 1602-L implemented using virtualization infrastructure 1604. The virtualization infrastructure 1604 runs on physical infrastructure 1605, and illustratively comprises one or more hypervisors and/or operating system level virtualization infrastructure. The operating system level virtualization infrastructure illustratively comprises kernel control groups of a Linux operating system or other type of operating system.

The cloud infrastructure 1600 further comprises sets of applications 1610-1, 1610-2, . . . 1610-L running on respective ones of the VMs/container sets 1602-1, 1602-2, . . . 1602-L under the control of the virtualization infrastructure 1604. The VMs/container sets 1602 may comprise respective VMs, respective sets of one or more containers, or respective sets of one or more containers running in VMs.

In some implementations of the FIG. 16 embodiment, the VMs/container sets 1602 comprise respective VMs implemented using virtualization infrastructure 1604 that comprises at least one hypervisor. A hypervisor platform may be used to implement a hypervisor within the virtualization infrastructure 1604, where the hypervisor platform has an associated virtual infrastructure management system. The underlying physical machines may comprise one or more distributed processing platforms that include one or more storage systems.

In other implementations of the FIG. 16 embodiment, the VMs/container sets 1602 comprise respective containers implemented using virtualization infrastructure 1604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1600 shown in FIG. 16 may represent at least a portion of one processing platform. Another example of such a processing platform is processing platform 1700 shown in FIG. 17.

The processing platform 1700 in this embodiment comprises a portion of system 100 and includes a plurality of processing devices, denoted 1702-1, 1702-2, 1702-3, . . . 1702-K, which communicate with one another over a network 1704.

The network 1704 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1702-1 in the processing platform 1700 comprises a processor 1710 coupled to a memory 1712. The processor 1710 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1712 may comprise random access memory (RAM), read-only memory (ROM), flash memory or other types of memory, in any combination. The memory 1712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1702-1 is network interface circuitry 1714, which is used to interface the processing device with the network 1704 and other system components, and may comprise conventional transceivers.

The other processing devices 1702 of the processing platform 1700 are assumed to be configured in a manner similar to that shown for processing device 1702-1 in the figure.

Again, the particular processing platform 1700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality of one or more components of the intelligent support framework 110 as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems and intelligent support frameworks. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
training at least one machine learning model with training data from a plurality of support cases;
receiving an input comprising data associated with at least one support case;
analyzing the input using the at least one machine learning model to determine one or more resolution options for the at least one support case; and
transmitting the one or more resolution options to an agent;
wherein the steps of the method are executed by at least one processing device operatively coupled to a memory.

2. The method of claim 1 further comprising performing natural language processing (NLP) on the training data from the plurality of support cases and the data associated with the at least one support case.

3. The method of claim 1 wherein the at least one machine learning model comprises a linear support vector machine (LSVM) classifier.

4. The method of claim 1 wherein the training data comprises for respective ones of the plurality of support cases at least one of a case title, a case description, affected device details and one or more elements requiring at least one of replacement and installation.

5. The method of claim 1 further comprising:
computing a degree of confidence for respective ones of the one or more resolution options; and
transmitting the computed degrees of confidence with the one or more resolution options to the agent.

6. The method claim 1 wherein the one or more resolution options comprise one or more recommendations for at least one of a replacement and an installation of an element.

7. The method of claim 6 wherein:
the element comprises a device part; and
the method further comprises recommending one or more alternative parts to be used instead of the device part, wherein the recommending is performed using at least one other machine learning model.

8. The method of claim 7 further comprising training the at least one other machine learning model with data comprising attributes and configurations for respective ones of a plurality of parts.

9. The method of claim 7 wherein the recommending comprises comparing the device part to a plurality of alternative parts to determine a level of similarity between the device part and respective ones of the plurality of alternative parts.

10. The method of claim 9 wherein the comparing is performed using at least one of a k-nearest neighbor (KNN) algorithm and a Euclidean distance algorithm.

11. The method of claim 1 further comprising evaluating performance of the at least one machine learning model, wherein the evaluating is performed using K-folds cross validation.

12. The method of claim 11 further comprising generating a visualization of the performance of the at least one machine learning model, wherein the visualization comprises a confusion matrix comprising dispatched resolutions versus recommended resolutions for a plurality of received support cases.

13. An apparatus comprising:
a processing device operatively coupled to a memory and configured:
to train at least one machine learning model with training data from a plurality of support cases;
to receive an input comprising data associated with at least one support case;
to analyze the input using the at least one machine learning model to determine one or more resolution options for the at least one support case; and
to transmit the one or more resolution options to an agent.

14. The apparatus of claim 13 wherein the one or more resolution options comprise one or more recommendations for at least one of a replacement and an installation of an element.

15. The apparatus of claim 14 wherein:
the element comprises a device part; and
the processing device is further configured to recommend one or more alternative parts to be used instead of the device part, wherein the recommending is performed using at least one other machine learning model.

16. The apparatus of claim 15 wherein the processing device is further configured to train the at least one other machine learning model with data comprising attributes and configurations for respective ones of a plurality of parts.

17. The apparatus of claim 15 wherein in performing the recommending, the processing device is configured to compare the device part to a plurality of alternative parts to determine a level of similarity between the device part and respective ones of the plurality of alternative parts.

18. An article of manufacture comprising a non-transitory processor-readable storage medium having stored therein program code of one or more software programs, wherein the program code when executed by at least one processing device causes said at least one processing device to perform the steps of:
training at least one machine learning model with training data from a plurality of support cases;
receiving an input comprising data associated with at least one support case;
analyzing the input using the at least one machine learning model to determine one or more resolution options for the at least one support case; and
transmitting the one or more resolution options to an agent.

19. The article of manufacture of claim 18 wherein the one or more resolution options comprise one or more recommendations for at least one of a replacement and an installation of an element.

20. The article of manufacture of claim 19 wherein:
the element comprises a device part; and
the program code further causes said at least one processing device to perform the step of recommending one or more alternative parts to be used instead of the device part, wherein the recommending is performed using at least one other machine learning model.
